(19) United States
(12) Patent Application Publication
(10) Pub. No.: US 2025/0067917 A1
(43) Pub. Date: Feb. 27, 2025

(54) FILTER STRUCTURE FOR INFRARED CAMERA, INFRARED CAMERA AND VIRTUAL REALITY DEVICE

(71) Applicants: Beijing Zitiao Network Technology Co., Ltd., Beijing (CN); Lemon Inc., Grand Cayman (KY)

(72) Inventors: Shaopeng ZHU, Beijing (CN); Xin LI, Beijing (CN); Ziyang ZHANG, Los Angeles, CA (US); Zhao ZHANG, Beijing (CN); Yan ZHOU, Beijing (CN); Xuan ZHONG, Beijing (CA)

(21) Appl. No.: 18/813,829

(22) Filed: Aug. 23, 2024

(30) Foreign Application Priority Data
Aug. 25, 2023 (CN) 202311089593.9

(51) Int. Cl. G02B 5/30; H04N 23/20

(52) U.S. Cl. CPC G02B 5/3016; H04N 23/20

(57) ABSTRACT

A filter structure for an infrared camera, the infrared camera and virtual reality device are disclosed. An embodiment of the filter structure includes at least one film, the at least one film includes at least one dichroic dye, the at least one dichroic dye is configured to absorb visible light, and molecular orientation of the dichroic dye of the at least one film includes at least two target directions, and any two directions of the at least two target directions are not parallel.

The application claims priority to the Chinese patent application No. 202311089593.9, filed on Aug. 25, 2023, the entire disclosure of which is incorporated herein by reference as part of the present disclosure.

### TECHNICAL FIELD

Embodiments of the present disclosure relate to the technical field of optical filtering, in particular to a filter structure for an infrared camera, an infrared camera and a virtual reality device.

### BACKGROUND

The application range of an infrared camera is very wide, the infrared camera can be used in various occasions and devices, for example, can be used in Virtual Reality (VR) devices to realize an eye tracking function, the eye tracking emits infrared light to human eyes by using infrared LED, so that the infrared camera can shoot infrared light reflected by human eyes and recognize the dynamics of human eyes in real time, thus realizing the interaction between human eyes and machines.

### SUMMARY

Embodiments of the present disclosure provide a filter structure for an infrared camera, an infrared camera and a virtual reality device.

In a first aspect, at least one embodiment of the present disclosure provides a filter structure for an infrared camera which comprises at least one film, the at least one film comprises at least one dichroic dye, the at least one dichroic dye is configured to absorb visible light, and molecular orientation of the dichroic dye of the at least one film comprises at least two target directions, and any two directions of the at least two target directions are not parallel.

In some embodiments, the at least one film comprises at least two of the dichroic dyes, and the at least two dichroic dyes comprise a dichroic dye that absorbs a blue color gamut and a dichroic dye that absorbs a red color gamut.

In some embodiments, the at least one film is at least two films, and the molecular orientation of the dichroic dye of each of the at least two films is in a same direction.

In some embodiments, the at least two target directions are determined according to an absorptivity of the at least one dichroic dye of the at least one film for visible light.

In some embodiments, the molecular orientation of the dichroic dye of each film of the at least one film is matched with a direction in which the dichroic dye of the each film has a highest absorptivity for visible light.

In some embodiments, the at least one film is two films, and the molecular orientations of the dichroic dyes of the two films are perpendicular to each other.

In some embodiments, the filter structure further comprises at least one selected from a group consisting an antireflection film for visible light, a phase retardation film for visible light and a circularly polarized light filter film for infrared light.

In some embodiments, the antireflection film is made by pressing a nano material with a moth-eye structure.

In some embodiments, the at least one thin film is made of orderly ordered molecules, and molecules of the at least one dichroic dye are constrained by the orderly ordered molecules, and the orderly ordered molecules are oriented in the at least two target directions.

In some embodiments, the orderly ordered molecules are linear polymers formed by stretching.

In some embodiments, the orderly ordered molecules are aligned liquid crystal molecules.

In some embodiments, molecules of the at least one dichroic dye possess orientability, and the molecules of the at least one dichroic dye that possess orientability are aligned so that the molecules are oriented in the at least two target directions.

In some embodiments, the at least one dichroic dye is an azo dichroic dye.

In a second aspect, at least one embodiment of the present disclosure provides an infrared camera which comprises: an infrared camera body and the filter structure according to the first aspect.

In a third aspect, at least one embodiment of the present disclosure provides a virtual reality device which comprises: an infrared camera and the filter structure according to the first aspect.

The filter structure, the infrared camera and the virtual reality device for the infrared camera provided by the embodiment of the disclosure, each of the three comprises at least one film, the at least one film comprises at least one dichroic dye, the at least one dichroic dye is configured to absorb visible light, and molecular orientation of the dichroic dye of the at least one film comprises at least two target directions, and any two directions of the at least two target directions are not parallel, so that the visible light is absorbed in at least two different directions, and thus the reflectivity of the visible light is reduced.

### BRIEF DESCRIPTION OF DRAWINGS

The above and other features, advantages and aspects of embodiments of the present disclosure will become more apparent by referring to the following detailed description when taken in conjunction with the accompanying drawings. Throughout the drawings, the same or similar reference numerals indicate the same or similar elements. It should be understood that the drawings are illustrative, and the components and elements are not necessarily drawn according to the real scales.

FIG. 1 is a schematic diagram of a filter structure for an infrared camera according to an embodiment of the present disclosure;

FIG. 2 is a schematic diagram of another filter structure for an infrared camera according to an embodiment of the present disclosure;

FIG. 3 is a schematic diagram of further another filter structure for an infrared camera according to an embodiment of the present disclosure;

FIG. 4 is a schematic diagram of still another embodiment of a filter structure for an infrared camera according to an embodiment of the present disclosure;

FIG. 5 is a structural schematic diagram of an infrared camera according to an embodiment of the present disclosure;

FIG. 6 is a structural schematic diagram of a virtual reality device according to an embodiment of the present disclosure.

### DETAILED DESCRIPTION

The application will be further described in detail with the attached drawings and examples. It can be understood that the specific embodiments described here are only used to explain the related invention, but not to limit the present disclosure. In addition, for the convenience of description, only the parts related to the present disclosure are shown in the attached drawings.

It should be noted that the embodiments in the present disclosure and the features in the embodiments can be combined with each other without conflict. The present disclosure will be described in detail with reference to the attached drawings and examples.

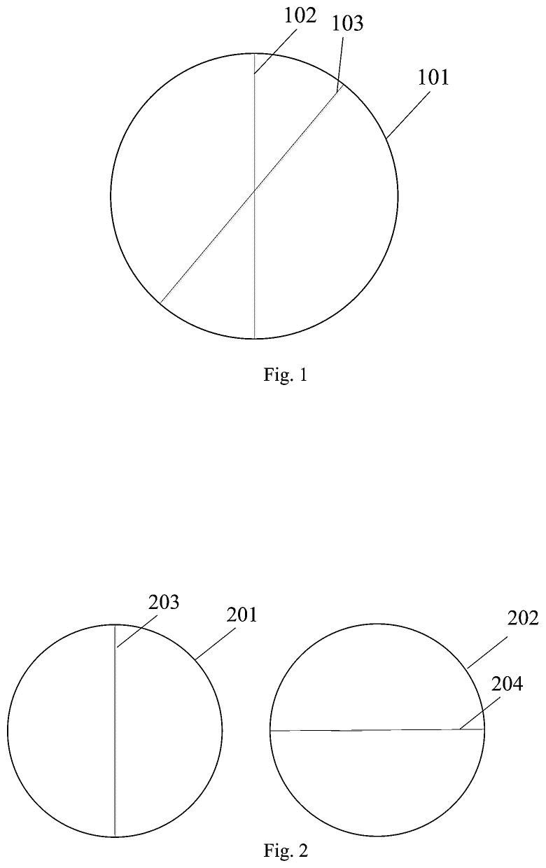

FIG. 1 shows a schematic diagram of a filter structure for an infrared camera according to an embodiment of the present disclosure. As shown in FIG. 1, the filter structure may include at least one film 101, and the at least one film 101 may include at least one dichroic dye which is usually used to absorb visible light.

Dichroic dyes usually have different optical absorption spectra for incident light in different polarization directions, and usually have a highest absorption coefficient for polarized light in one direction, while a lowest absorption coefficient for polarized light in another direction (generally perpendicular to the direction with the highest absorption coefficient). Dichroic dyes may include, but are not limited to, anthraquinone dichroic dyes, triphenyl diazine and its derivatives dichroic dyes, monomethine dichroic dyes and polymethine dichroic dyes.

It should be noted that if the at least one film contains at least two dichroic dyes, the at least two dichroic dyes may be the same dichroic dye or different dichroic dyes.

The molecular orientation of dichroic dye contained in the at least one film of film 101 may be at least two target directions, as indicated by icons 102 and 103, and any two directions of the above-mentioned at least two target directions are generally non-parallel. As an example, an included angle between the two directions may be in a range of 30°˜90°, or more specifically, 60°˜90°.

Here, an order parameter can be used to define any direction (generally the direction of the length of the dye molecule) of a dye molecule as a main axis direction of the dye molecule, so that the main axis directions of all dye molecules have an average direction.

Assuming that the main axis directions of all dye molecules are along the average direction, that is, the orientations of all dye molecules are uniformly and neatly arranged, the order parameter S of the dye molecules satisfies that S=<3/2cos\hat{ }2θ-1/2>=1, in which θ is the included angle between the main axis of each dye molecule and the average direction, <> means to average the order parameters of all the dye molecules, and if the dye molecules are completely confused, the order parameter S is equal to 0.

As an example, the filter structure can be a thin film, and the molecular orientations of the dichroic dye contained in one thin film can be at least two target directions, for example, two target directions.

Here, the above-mentioned filter structure can be a filter film formed by stacking the at least one film together, or a filter plate (for example, filter glass), and the filter plate can be obtained by plating the above-mentioned at least one film on a glass sheet.

Through the filter structure for infrared camera disclosed by the present disclosure, visible light can be absorbed in at least two different directions, and thus the reflectivity of visible light is reduced. In addition, the filter structure can be highly transparent to the working wavelength of the infrared camera, thus improving the transmittance of infrared light.

In some alternative implementations, the at least one film may contain at least two dichroic dyes, the at least two dichroic dyes may include a dichroic dye that absorb a blue color gamut and a dichroic dye that absorb a red color gamut. The dichroic dye that absorbs the blue color gamut can be understood as a dye with obvious dichroism for the blue waveband, and the dichroic dye that absorbs the red color gamut can be understood as a dye with obvious dichroism for the red waveband.

Because some dichroic dyes have obvious dichroism for the blue waveband, and some dichroic dyes have obvious dichroism for the red waveband, while blue light and red light are almost at the two ends of the visible light range, most bands of visible light can be absorbed by using dichroic dyes that absorb the blue color gamut and dichroic dyes that absorb the red color gamut, and the reflectivity of most visible light can be further reduced in this way.

In some alternative implementations, the at least one film can be at least two films, and the at least two films can be directly overlapped with each other, or can be overlapped with each other by an adhesive layer (for example, Optically Clear Adhesive (OCA)). The molecular orientation of dichroic dyes in each film of the at least two film can be in the same direction, that is, the molecular orientation of dichroic dyes in each film of at least two films is usually in the same direction. If the order parameter S is used to define the orientation of the dye molecules, the molecular orientation of dichroic dyes preferentially points in one direction, it can be understood as the order parameter S>0.3, or more specifically, S>0.7. It should be noted that the larger the order parameter, the more uniform and neater the molecular orientation.

As an example, if the at least one film are two films, the molecular orientations of the dichroic dye of the first film among the two films are all in the same direction, and the molecular orientations of the dichroic dye of the second film among the two films is the same direction, and the molecular orientations of the two films are not parallel.

In some alternative implementations, the at least two target directions can be determined according to the absorptivity of the at least one dichroic dye of the at least one film for visible light. Generally speaking, the absorptivity of a dichroic dye for visible light in different directions on a plane are different, and thus at least two target directions can be determined by the absorptivity. For example, at least two directions corresponding to absorptivity greater than an absorption threshold can be selected as the target directions, or at least two directions can be selected as the target directions in the order of absorptivity from large to small. After the target direction is determined, a corresponding film containing the dichroic dye can be prepared for the target direction. In this way, the absorption effect of the filter structure on visible light can be improved.

In some alternative implementations, the molecular orientation of the dichroic dye of each film of the at least one film is matched with a direction in which the dichroic dye of the each film has a highest absorptivity for visible light, that is, the molecular orientation of dichroic dyes in each film preferentially points in the same direction, so that the plane of the film has the direction with the highest absorptivity of visible light macroscopically. That is to say, once the molecular orientation of the dichroic dye is determined, the direction with the highest absorptivity of visible light is determined, and the determined direction with the highest absorptivity can be used as the above-mentioned target direction during preparing the filter structure. In this way, the absorption effect of the filter structure on visible light can be further improved.

In some alternative implementations, the at least one film may be two films, and the molecular orientations of the dichroic dyes of the two films may be perpendicular to each other, that is, the included angle between the two directions is 90 degrees. If the two directions of molecular orientation are perpendicular to each other, the absorptivity of visible light can reach a higher value. As an example, as shown in FIG. 2, FIG. 2 shows a schematic diagram of another filter structure for an infrared camera according to an embodiment of the present disclosure. In FIG. 2, the filter structure includes two films, namely, a film 201 and a film 202, and the molecular orientation of the dichroic dye of the film 201 is in a north-south direction, as shown by the icon 203. The molecular orientation of the dichroic dye of the film 202 is in an east-west direction, as shown by the icon 204. The film 201 absorbs visible light in the north-south direction and the film 202 absorbs visible light in the east-west direction, that is, these two films can absorb visible light in most directions. In this way, the absorption effect of the filter structure on visible light can be further improved, so that the filter structure can absorb most visible light.

In some alternative implementations, the filter structure may include at least one selected from a group consisting an antireflection film for visible light, a phase retardation film for visible light and a circularly polarized light filter film for infrared light. Anti- reflection film can also be called a film for increasing transmittance, and the main function of the anti-reflection film is to reduce or eliminate the reflected light from optical surfaces such as lens, prism and plane mirror, so as to increase the light transmission of these components and reduce or eliminate stray light of the system. The phase retardation film reduces the reflectivity of visible light by delaying the phase of visible light. Antireflection film and phase retardation film are usually attached to the outer surface of infrared camera.

Here, the antireflection film may be a multilayer metal oxide deposited by Physical Vapor Deposition (PVD) or a porous nano-oxide particle coated by wet method. Physical vapor deposition (PVD) technology refers to the technology that the surface of material source (solid or liquid) is gasified into gaseous atoms or molecules or partially ionized into ions by physical methods under vacuum conditions, and a thin film with a certain special function is deposited on the substrate surface through the process of low-pressure gas (or plasma).

The light indicated by rotating the endpoint of an electric vector to trace a circular trajectory is called circularly polarized light. If two plane polarized light with a same propagation direction, perpendicular vibration directions and constant phase difference φ'(2m+1/2)π are superimposed, circularly polarized light with a regularly changing electric vector can be synthesized. The circularly polarized light filter film may be attached to the outer surface of the infrared camera, or may be attached at the middle of the at least two films, or may be attached on the inner surface of the infrared camera.

In this way, the antireflection film or the phase retardation film can be used to reduce the reflectivity of visible light, and in addition, the antireflection film can also improve the transmittance of infrared light. The circularly polarized light filter film can reduce the infrared ghost of the infrared camera.

In some alternative implementations, the antireflection film may be made by pressing a nano material with a moth-eye structure. If the size of the sub-micron structure on the surface of the material is smaller than the wavelength of light, the light wave will not recognize the sub-micron structure, so the refractive index on the surface of the material changes continuously along a depth direction of the material, which can reduce the reflection phenomenon caused by the sharp change of refractive index. Adopting the antireflection structure with the moth-eye structure has excellent antireflection effect on infrared waveband.

In some alternative implementations, the at least one film of thin film 101 may be prepared by using orderly ordered molecules, and the molecules of at least one dichroic dye may be constrained by the orderly ordered molecules in the thin film to be oriented. In this case, the orderly ordered molecules are usually oriented in at least two target directions, so that the molecules of dichroic dye are oriented in the at least two target directions. In this way, other orderly ordered molecules can be used to constrain the molecules of the dichroic dye so as to orient the molecules of the dichroic dye.

In some alternative implementations, the orderly ordered molecules can be linear polymers formed by stretching, and the linear polymers are usually long chains, for example, polyvinyl alcohol (PVA).

In some alternative implementations, the orderly ordered molecules may be aligned liquid crystal molecules. Generally, the liquid crystal molecules are dissolved in a solvent first, and a thin film can be formed by coating, and then the molecular orientation of the dichroic dye is constrained to point in one direction preferentially by any one selected from a group consisting of optical alignment, electric field alignment and shear force alignment. The optical alignment technology usually refers to the use of ultraviolet light to irradiate a liquid crystal alignment film, so that liquid crystal molecules are arranged in a certain order. The electric field alignment usually refers to the use of electric field to enable the liquid crystal molecules to be arranged in a certain order. The shear force alignment usually means that liquid crystal molecules are aligned in the direction of the force by using a force that can cause shear deformation of the material.

In some alternative implementations, the molecules of the dichroic dye possess orientability, for example, rod-like molecules with dichroic properties. The molecules of the at least one dichroic dye that possess orientability are aligned so that the molecules are oriented in the at least two target directions. Here, any one selected from the group consisting of optical alignment, electric field alignment and shear force alignment can be used for alignment.

In some alternative implementations, the adopted dichroic dye may be an azo dichroic dye, for example, a bisazo dichroic dye or a triazo dichroic dye. The azo dichroic dye can achieve high visible light absorptivity and high infrared light transmittance at the same time.

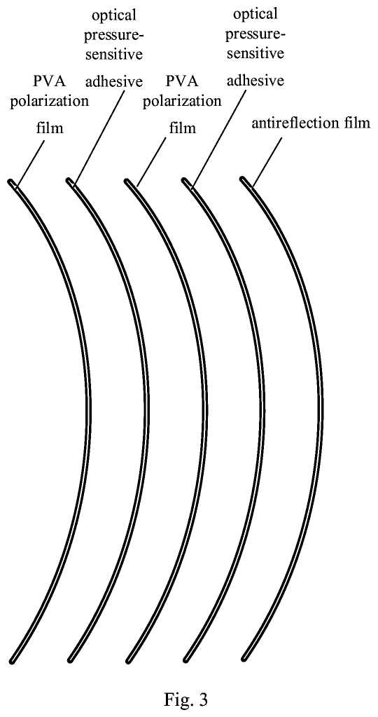

As an example, as shown in FIG. 3, FIG. 3 shows a schematic diagram of further another filter structure for an infrared camera according to an embodiment of the present disclosure. In FIG. 3, the filter structure can include two films with azo dichroic dye molecules, one of which is a PVA polarization film with a thickness of 35 μm (micron) and the other is also a PVA polarization film with a thickness of 30 μm. The two films were bonded with 15 μm optical pressure-sensitive adhesive, so that the included angle of the axial directions of the two films with the highest absorptivity was close to 90°.

In order to further reduce the reflectance of visible light and improve the transmittance of light close to the infrared light, an antireflection film with an antireflection coating may be attached to the outer side of the above-mentioned composite film, for example, as illustrated in FIG. 3, with optical pressure-sensitive adhesive. The antireflection coating may be by pressing a nano material with a moth-eye structure, and the antireflection coating also has excellent antireflection effect on infrared band. The average visible light (400 nm˜ 700 nm) reflectivity of the filter structure obtained in this way is less than 1%, while the transmittance of light with a wavelength of 850 nm, which is commonly used in eye tracking infrared cameras, can reach more than 95%.

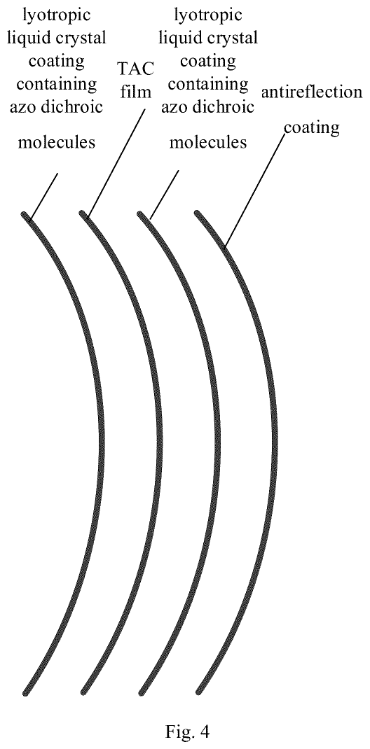

As another example, as shown in FIG. 4, FIG. 4 shows a schematic diagram of still another filter structure for an infrared camera according to an embodiment of the present disclosure. In FIG. 4, a 40 μm TAC (Tri-Aacetyl Cellulose) film is selected as the bonding layer of two overlapping films that include the dichroic dyes. On the two surfaces of the TAC film, lyotropic liquid crystal coatings with a dry film thickness of 2 μm are coated by slit coating, the lyotropic liquid crystal coatings may be obtained by aligning liquid crystal molecules through the shearing force during coating. In this way, by changing the coating directions of the front and back sides of the TAC film, the orientations of the liquid crystal films on the front and back sides face of the TAC film can be a direction X and a direction Y respectively, that is, the orientation axes of the two are 90°. Then the TAC film is immersed in a solution containing azo dichroic molecules for dyeing, and the azo dichroic molecules form polarized films on two sides of the TAC film, an included angel between the directions in which the azo dichroic molecules has the highest absorptivity of the polarized films on the two sides of the TAC film is equal to 90°. Next, the optical pressure- sensitive adhesive is attached to one side of the TAC film, and a hardening coating and an antireflection coating are coated on the other side of the TAC film, thus forming an extremely thin filter structure that has adhesive on one side thereof, and is suitable for being attached to a curved surface of a lens of the camera.

It should be noted that the above example is only a schematic illustration of forming the filter structure described in this disclosure, but it does not cover the scope of the present disclosure. For example, the film with the dichroic dye may include photoaligned lyotropic liquid crystal and the alignment layer of the photoaligned lyotropic liquid crystal in addition to the PVA polarization film and lyotropic liquid crystal aligned by shear force mentioned above, and the corresponding formation method of this type of the film may also include coating two films that include dichroic dyes respectively with different orientations on one side of a TAC/SRF/PMMA (Polymethyl Methacrylate)/COP or other films.

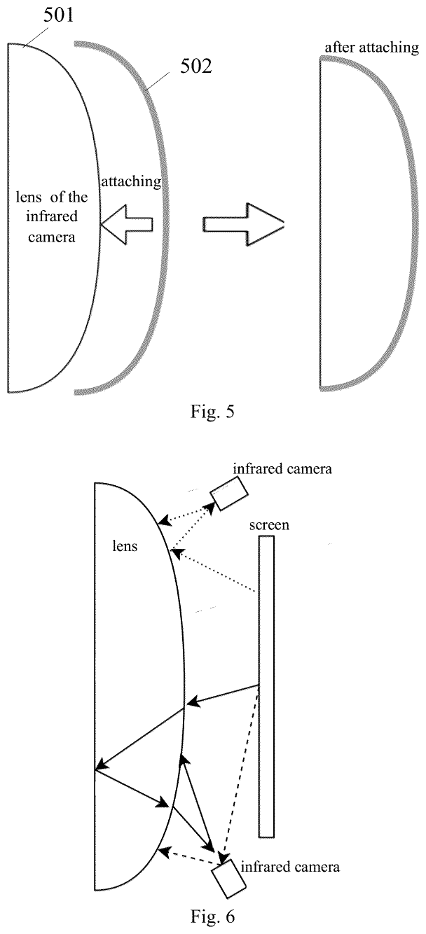

Please refer to FIG. 5, which is a structural schematic diagram of an infrared camera according to an embodiment of the present disclosure. In FIG. 5, the infrared camera may include an infrared camera body and any one of the filter structures 502 according to the embodiments of the present disclosure. The filter structure 502 may be a filter film. In this case, the filter film may be attached to the outer surface of the lens 501 of the infrared camera body. The filter structure 502 may also be prepared as a separate filter plate, and the filter plate can be used together with the infrared camera body to obtain the infrared camera with the filter structure. The infrared camera with the filter structure can absorb visible light in at least two different directions, so that the reflectivity of visible light is reduced, and the imaging stray light ghost caused by the reflection of visible light by the lens is reduced. In addition, the filter structure can be highly transparent to the working wavelength of the infrared camera, thereby improving the transmittance of infrared light.

With further reference to FIG. 6, FIG. 6 is a structural schematic diagram of a virtual reality device according to an embodiment of the present disclosure. In the virtual reality (VR) device in FIG. 6, the infrared camera is placed between the VR lens and the screen, so that the infrared signal is received by the infrared camera through the lens. In this way, the infrared camera is hidden in the lens for human eyes, which is more beneficial to the miniaturization of the device and the immersion feeling of no interference near the eyes if a user wears the virtual reality device.

However, the infrared camera receives the infrared signal through the lens, which means that the lens of the infrared camera must face the VR lens, because the lens of the infrared lens is made of an infrared sensitive material, the transmittance and reflectivity of infrared light are optimized, but the reflectivity of the visible light of the lens of the infrared camera cannot be optimized, so there is strong visible light reflection. If the VR device is working, the infrared camera will reflect the visible light in the optical system to the lens surface, which interferes with imaging and brings ghost and stray light.

In FIG. 6, the dot dotted line indicates that light from the screen is reflected by the back of the lens, and then reflected by the infrared camera, and enters the optical path, forming a ghost formed by stray light; the solid line indicates that light from the screen is reflected by the left surface of the lens in FIG. 6, then reflected by the infrared camera, and enters the optical path, forming a ghost formed by stray light; the long dotted line indicates that light from the screen is directly reflected by the infrared camera and enters the optical path, forming a ghost formed by stray light.

Here, the filter structure described in the embodiments of the present disclosure can be used in conjunction with the lens of the infrared camera shown in FIG. 6, so that the visible light reflectivity on the surface of the infrared camera is extremely low, which basically does not bring the ghost formed by stray light of visible light, but has the lowest influence on the infrared light transmittance at the working wavelength of the infrared camera, so that eye movement tracking based on infrared light can be carried out normally.

It should be noted that the VR device shown in FIG. 6 is only an example, and the filter structure described in the embodiment of the present disclosure may be a filter film, which can be attached to the outer surface of the lens of any VR device including an infrared camera, thus realizing the above functions. The filter structure described in the embodiment of the present disclosure can also be made into a separate filter plate, and the filter plate can be used in conjunction with the lens of a VR device including an infrared camera to realize the above functions.

It should also be noted that the filter structure of the present disclosure can be applied not only to VR devices using eye tracking, but also to multiple application scenarios such as shielding infrared sensors, removing visible light interference from an infrared sensor or a camera, and removing visible light interference from an infrared camera.

The above description is only the preferred embodiment of the present disclosure and the explanation of the applied technical principles. It should be understood by those skilled in the art that the scope of the present disclosure involved in the embodiments of this disclosure is not limited to the technical scheme formed by the specific combination of the above technical features, but also covers other technical schemes formed by any combination of the above technical features or their equivalent features without departing from the above inventive concept. For example, the above features are replaced with (but not limited to) technical features with similar functions disclosed in the embodiments of the present disclosure.

1. A filter structure for an infrared camera, comprising:
at least one film, wherein the at least one film comprises at least one dichroic dye, the at least one dichroic dye is configured to absorb visible light, and molecular orientation of the dichroic dye of the at least one film comprises at least two target directions, and any two directions of the at least two target directions are not parallel.

2. The filter structure according to claim 1, wherein the at least one film comprises at least two of the dichroic dyes, and the at least two dichroic dyes comprise a dichroic dye that absorbs a blue color gamut and a dichroic dye that absorbs a red color gamut.

3. The filter structure according to claim 1, wherein the at least one film is at least two films, and the molecular orientation of the dichroic dye of each of the at least two films is in a same direction.

4. The filter structure according to claim 3, wherein the at least two target directions are determined according to an absorptivity of the at least one dichroic dye of the at least one film for visible light.

5. The filter structure according to claim 4, wherein the molecular orientation of the dichroic dye of each film of the at least one film is matched with a direction in which the dichroic dye of the each film has a highest absorptivity for visible light.

6. The filter structure according to claim 3, wherein the at least one film is two films, and the molecular orientations of the dichroic dyes of the two films are perpendicular to each other.

7. The filter structure according to claim 1, wherein the filter structure further comprises at least one selected from a group consisting an antireflection film for visible light, a phase retardation film for visible light and a circularly polarized light filter film for infrared light.

8. The filter structure according to claim 7, wherein the antireflection film is made by pressing a nano material with a moth-eye structure.

9. The filter structure according to claim 1, wherein the at least one thin film is made of orderly ordered molecules, and molecules of the at least one dichroic dye are constrained by the orderly ordered molecules, and the orderly ordered molecules are oriented in the at least two target directions.

10. The filter structure according to claim 9, wherein the orderly ordered molecules are linear polymers formed by stretching.

11. The filter structure according to claim 9, wherein the orderly ordered molecules are aligned liquid crystal molecules.

12. The filter structure according to claim 1, wherein molecules of the at least one dichroic dye possess orientability, and the molecules of the at least one dichroic dye that possess orientability are aligned so that the molecules are oriented in the at least two target directions.

13. The filter structure according to claim 1, wherein the at least one dichroic dye is an azo dichroic dye.

14. An infrared camera, comprising: an infrared camera body and the filter structure according to claim 1.

15. A virtual reality device, comprising: an infrared camera and the filter structure according to claim 1.
